(19) United States
(12) Patent Application Publication
(10) Pub. No.: US 2019/0024702 A1
(43) Pub. Date: Jan. 24, 2019

(54) Method of Designing and Producing Connecting Rods formed of Fiber Composite Material

(71) Applicant: Bryan Gill, Rancho Palos Verdes, CA (US)

(72) Inventor: Bryan Gill, Rancho Palos Verdes, CA (US)

(21) Appl. No.: 16/041,464

(22) Filed: Jul. 20, 2018

Related U.S. Application Data
(60) Provisional application No. 62/534,956, filed on Jul. 20, 2017.
(60) Provisional application No. 62/535,002, filed on Jul. 20, 2017.
(60) Provisional application No. 62/541,535, filed on Aug. 4, 2017.

(51) Int. Cl. F16C 7/02; B29C 70/12; B29C 70/44; B29C 70/54

(52) U.S. Cl. CPC F16C 7/026; F16C 7/023; B29C 70/12; B29C 70/443; B29K 2307/04; F16C 2208/02; F16C 2220/08; F16C 2223/42; B29C 2793/009; B29C 70/545

(57) ABSTRACT

A method of designing and producing a connecting rod using chopped carbon fiber pre-impregnated composite material is provided. The method allows connecting rod designers to machine several different connecting rod designs, lengths, and beams. The connecting rod is first cast, forged or otherwise shaped in a basic form, and then machined into a specific connecting rod. After the specific machining is performed, the big-end and small-end bosses are bored, bolt holes drilled, and then all surfaces are finished or machined. The starting material is preferably a chopped fiber or woven fiber composite, and the connecting rods are then plated to seal carbon fiber based materials and the big-end rod bearing inserts are placed along with the rod's small-end bushing. In one embodiment interlocking serrations are machined onto opposing surface faces of the two halves of the rod, allowing the cap and beam to be aligned without requiring special alignment dowels, yet forming a unitary, and stronger rod assembly. The finished machined connecting rod pieces, then rods are plasma coated with anti-friction material(s), for example are plasma-nitrided.

### FIELD OF THE INVENTION

The present invention relates to automotive connecting rod manufacturing and methods of designing and producing composite connecting rods. More specifically, the present invention pertains to a new method of designing and producing a composite connecting rods using compression molded, chopped composite material that is machinable after being formed, along with a design process that allows several different designs to be machined from a shaped mold of composite material.

Automotive connecting rods are well known structures that join the pistons with the crank. High performance connecting rods are lightweight and high strength structures that can be specifically designed to increase power and be sufficiently durable for competition or rigorous use. High performance and exotic engines are not the only engines in which may benefit from this technology. Connecting rods can be replaced for increased performance to increase fuel economy. The present invention is directed to a new method of manufacturing and designing high performance connecting rods, which aims to increase performance thereof while maintaining a high degree increased power and economy.

The present invention relates to a new method of designing and producing composite connecting rods, and in particular carbon fiber connecting rod designs that do not require specific molds or different sizes, those with different can be formed into a shape using a compression molding technique. The resulting material is non-directional and conforms to the shape of the mold, wherein the chopped fibers are supported within a matrix in random directions to produce an overall quasi-isotropic material system. Using this material, the connecting rod design process benefits and can utilize the fact that this material system is machinable after being formed. Further provided is an efficient design method that utilizes the chopped composite material system to create a connecting rod blank that is adaptable to different diameters and beam types while minimizing lost materials during the machining process. Once the connecting rod design is machined, the connecting rod can then be plated, bosses bored on big-end and small-end, bolt holes drilled for joining the cap and beam, and anti-friction plated or coated.

The present invention comprises a new design and manufacturing method of composite connecting rods may be implemented using chopped carbon fiber material, wherein the design reduces material waste, reduces engineering design expense for each connecting rod design, and reduces the cost of composite connecting rods to consumers. Various molds are used to accommodate a plurality of connecting rod designs, lengths, diameters, and beam types, whereby the resulting connecting rod blank from the single mold process is machined to a specific size and shape for the desired connecting rod. The resulting connecting rod then joins the piston with the crank to produce a high performance assembly at a reduced cost and weight compared to traditional methods of aluminum in the market.

It is submitted that the present invention is substantially diverges in design elements and method steps from the prior art, and consequently it is clear that there is a need in the art for an improvement to existing aluminum connecting rod designs and manufacturing methods. In this regards the instant invention substantially fulfills these needs.

### SUMMARY OF THE INVENTION

In the view of the foregoing disadvantages inherent in the known types of aluminum connecting rods and design and manufacturing methods present in the art, the present invention provides a new design and manufacturing method wherein the same can be utilized for producing a composite connecting rod that reduces cost and wasted material to produce a lightweight, high performance connecting rod for competition or road use. The manufacturing method results in lighter weight (reducing the power lost in acceleration), and in the flexibility to readily adapt the connecting rod to different pistons, or to engine with different length strokes.

The method includes a process of forming chopped carbon fiber material into a connecting rod blank that is machinable to the end design of the given connecting rod.

Another objective of the present invention is to provide a design method for creating a composite connecting rod in which one mold can be utilized to create a connecting rod blank that accommodates a plurality of different connecting rod designs, whereby the final design is machined from the singly designed blank.

Another objective of the present invention is to provide design method of composite connecting rods that aims to increase efficiency to the end consumer, while still retaining the primary advantages associated with composite connecting rods (light weight, high stiffness, high strength, greater fatigue life, etc.).

Other objectives, features, and advantages of the present invention will become apparent from the following detailed description taken in conjunction with the accompanying drawings.

### BRIEF DESCRIPTION OF THE DRAWING

FIG. 1 shows a perspective view, partially schematic of a connecting rod and designs in accordance to the present invention including: brass insert, connecting rod body made up of composite material.

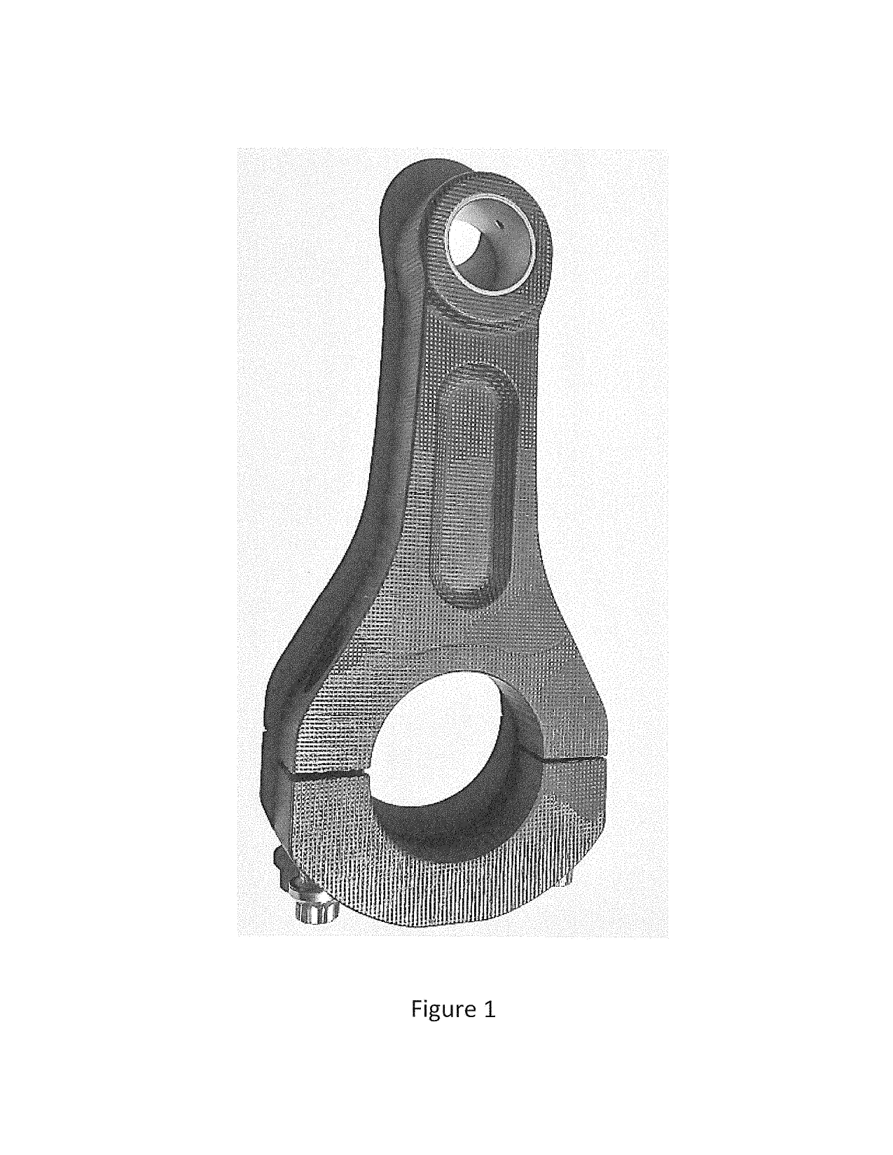

### DETAILED DESCRIPTION OF THE INVENTION

Reference is made herein to the attached drawings. Like reference numerals are used throughout the drawings to depict like or similar elements of the present method. For the purposes of presenting a brief and clear description of the present invention, the preferred embodiment will be discussed as used for creating a composite connecting rod blank using chopped carbon fiber material and a design process that minimizes waste and costs. The FIGURES are intended for representative purposes only and should not be considered to be limiting in any respect.

The present invention is a new design method and method of manufacturing for connecting rods using composite material, wherein the production of the connecting rod involves a forming process and the design method allows for multiple different connecting rod designs to be incorporated into a single manufacturing process. The design method reduces material waste and costs of the connecting rod for the end consumer, while maintaining the benefits offered by composite connecting rods. Specifically, chopped carbon fiber reinforced polymer is used to create the connecting rod, wherein the chopped fiber is placed into a mold, compression molded into a formed shape, and then machined into a final connecting rod design. The use of chopped fibers and a forming process allows designers and fabricators to machine the final design from a larger connecting rod blank, which allows one connecting rod blank to be utilized for multiple connecting rod designs without individually engineering each connecting rod and creating a specific mold for each connecting rod design. This eliminates the traditional aluminum forging process and replaces it with a carbon fiber based material.

Thus, the present invention contemplates creating a composite connecting rod blank of carbon fiber, but rather than forging aluminum, the present invention method utilizes a chopped fiber compression molding process and a design process similar to aluminum connecting rod fabrication but with carbon fiber based material which leads to greater RPM optimization due to the light weight. A shaped connecting rod blank is created from the combination of several different connecting rod designs, which can then be machined down to the exact connecting rod design chosen by the end user. Connecting rod designs are overlaid onto one another in a design space to establish the shape of the connecting rod blank to be created from the chopped carbon fiber material in a mold. The process can accommodate connecting rods of different diameter, length, beam type and design, wherein the final product connects the piston with the crank having specific journal size and piston stroke.

Once released from the mold, the carbon fiber connecting rod blank is machined into a specific and precise final design. A CNC milling machine or similar device is utilized to machine the larger connecting rod blank into the final connecting rod design.

In a preferred embodiment, the machined, chopped fiber matrix composite rod body is sealed, for example by impregnating with an N Sodium Silicate solution to prevent fluid uptake in the carbon matrix composite based materials. This method of sealing has been used to stabilize and prevent corrosion of the areas of sponge-like internal structure in an otherwise sound but porous metal parts. Conventionally, porosity may be caused by internal shrinkage, gas cavitation, oxide films, inclusions and combinations thereof. It can be found in virtually any type of metal casting or part, and is a problem in castings made from aluminum, zinc, bronze, iron, magnesium, and other alloys. Porosity is always present in powdered or sintered metal parts because of their structural nature.

Various methods have been used to attempt filling porous openings in parts designed to contain liquids or gases under pressure. One of the first materials used for impregnation was “water-glass” or sodium silicate. In addition to sodium silicate, tung oil, linseed oil, pitch gum and many other materials were used with little success. Shortly after World War II, the development of thermosetting plastics, to be used as impregnate, became an effective and economical means of sealing porosity within the walls of metal castings, especially when used in conjunction with vacuum pressure impregnation techniques.

In the realm of advanced composites and an ever-changing world with more demands placed upon the scientific community for greater efficiency, there's a need to produce component and products lighter and more efficient. With the advent of carbon based materials, the problem of porosity persisted, and thus the need for sealing composite based materials. We have now successfully impregnated carbon-based matrix and composites materials with “Sodium Silicates Solutions” to address the fluid uptake issues.

The impregnating material, as a liquid, is introduced into the voids or porosity within the wall of the part usually using vacuum and pressure. The material is then solidified, filling the porous openings and making the part pressure tight. Impregnation of powdered metal parts not only seals parts for pressure applications, but also improves plating or finishing, since bleed out or spotting due to entrapment of plating solutions in the pores is eliminated. Extended tool life is another benefit when machining powdered metal parts. Because of the proven effectiveness and economies of impregnation, many engineers specify its use for all types of metal parts that must contain liquids or gases under pressure. It is now common for impregnation processes to be incorporated directly into production schedules to insure quality, rather than to be used strictly as a salvage operation.

While impregnation has been highly effective for use on metal as the primary application, until now it has not been applied to carbon based or composite based materials substrates. Here we have employed Sodium Silicate Solution as a technique for sealing or eliminating the porosity issues inherent in carbon based matrix composites by using impregnation with Sodium Silicate Solution.

There are two general classifications of porosity found in metal parts: macro-porosity in the form of large flaws in the part which may be visible to the naked eye; and micro-porosity in the form of very small, almost invisible voids. In various metal and car on based matrix composites and some powdered metal parts, the structure of the metal results in a condition similar to macro-porosity in castings having low density, and micro-porosity in high density castings. Porosity can be found as “continuous, blind or totally enclosed”. Continuous porosity stretches completely through the wall thickness of a metal part causing a leakage path. Blind porosity is connected only to one side of the part wall. Totally enclosed porosity is totally isolated within the wall thickness of a part. When metal castings are machined, both blind and totally enclosed porosity are often “opened up” becoming continuous porosity and causing leaks. Modern “Impregnation Technology” permanently seals porosity leaks caused by either micro- or macro-porosity, in carbon based matrix composites and metal.

There are four common methods of impregnation consisting of dry vacuum-pressure, internal pressure, wet vacuum-pressure and wet vacuum only. The dry vacuum-pressure is accomplished as follows:
1. Within an autoclave a vacuum is drawn, the air in the pores is evacuated without an impregnating liquid present to impede the evacuation to a level of 15 to 35 torr.
2. The liquid Sodium Silicate Solution is introduced while the parts are still under vacuum
3. A pressure cycle, up to 80-90 psi of shop air pressure (or up to six atmospheres) forces the Sodium Silicate Solution deep into the porous cavities of the part for more positive sealing.
4. After the impregnation cycle the part is removed from the autoclave, the surface is then rinsed in plain water, leaving no evidence or film of the impregnating material on the part surface. Machined surfaces or tolerances are not affected. The liquid material in the pores is cured by the application of heat.
5. Internal impregnation is accomplished by placing the Sodium Silicate Solution inside the casting and applying hydraulic pressure. This procedure is utilized in extremely large castings, forcing the liquid Sodium Silicate Solution through the leak paths in the casting wall.
6. Wet vacuum-pressure and wet vacuum only differ in the application of pressure. They both introduce parts into an Sodium Silicate Solution bath and evacuate the air above the bath and subsequently from the porosity of the parts through the surrounding liquid Sodium Silicate Solution. Pressure, either atmospheric or shop air is then applied to aid penetration of Sodium Silicate Solution into the component body.

The foregoing description of the instant invention sets forth practical and preferred method steps. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function, steps, and manner of operation, assembly and use, are deemed readily apparent and obvious to one skilled in the art, and all equivalent relationships to those it in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method of designing and producing fully plated, composite connecting rods using a carbon based composite material, compromising the steps of:
choosing one or a plurality of connecting rod designs;
overlaying said connecting rod designs to determine a single connecting rod blank design;
creating a reverse mold of said connecting rod blank design;
compression molding a connecting rod blank using said reverse mold;
machining said connecting rod blank into one of said connecting rod designs.

2. The method of claim 1, wherein said choosing said connecting rod designs further comprises the steps of:
determining diameter, length, and beam type of said connecting rod designs prior to overlaying said connecting rod designs.

3. The method of claim 2, wherein compression molding said connecting rod blank further comprising the steps of:
heating composite material;
communicating said composite material after heating into said mold;
compressing said material in said mold using a press;
removing said material after cooling.

4. The method of claim 3, wherein compression molding said connecting rod blank further compromising one or more of the steps of:
machining the connecting rod to formed aligned cap and beam portions;
sealing the connecting rod with a silicate, and/or
plasma coating the connecting rod with anti-friction material.

5. A method of sealing against porosity of carbon matrix composite as a safeguard against fluid uptake in carbon fiber or carbon matrix composites.
